(19) United States
(12) Patent Application Publication
(10) Pub. No.: US 2007/0203832 A1
(43) Pub. Date: Aug. 30, 2007

(54) Intermediary payment system and method for gaming

(76) Inventors: Rene Pierre Babi, Vancouver, WA (US); Mark Mathias Silbernagel, Battle Ground, WA (US)

Correspondence Address: Lawrence D.Eisen;Pillsbury Winthrop Shaw Pittman, 1650 Tysons Boulevard, McLean, VA, 22102, US

(21) Appl. No.: 11/445,297

(22) Filed: Jun. 2, 2006

Related U.S. Application Data
(60) Provisional application No. 60/776,956, filed on Feb. 28, 2006.

(51) Int. Cl. G06Q 40/00

(52) U.S. Cl. 705/39

(57) ABSTRACT

A method for enabling consumers in a gaming context to push funds from a traditional open loop account to a closed loop account, and back. At the request of a consumer, funds are transferred to an open loop account of an intermediary payment system that holds or keeps track of virtual closed loop accounts for each consumer and virtual closed loop accounts for individual games, casinos or gaming establishments. The consumer may use an associated closed loop card to place a bet at the gaming establishment that will cause funds to be transferred from the consumer's virtual closed loop account to the gaming establishment's closed loop account. Thereafter, the funds are transferred from the intermediary payment system to an open loop account belonging to the gaming establishment.

This application claims the benefit of U.S. Provisional Application No. 60/776,956, filed Feb. 28, 2006, which is incorporated herein by reference it its entirety.

### FIELD OF THE INVENTION

The present invention is related to the financial services industry. More particularly, the present invention is related to facilitating funds transfers between accounts in unrelated and respectively isolated financial systems.

### BACKGROUND OF THE INVENTION

Consumers presently enjoy tremendous capability to purchase goods and services, i.e., conduct financial transactions, almost anywhere in the world. The US banking system, in particular, facilitates this activity, through conventional means such as wire-transfers, checks and funds-transfers through the automated clearing house network (ACH—operated by The Electronic Payments Association, NACHA), and through regional networks such as Star and Mac, or national and international networks such as MasterCard, Visa, Amex, and so on. Often, traditional bank accounts are connected to these various networks by an issuing bank, and the consumer is given a card (debit or credit), which they present at a point of sale, or simply enter the account number on the card into a web page for an online purchase. The purchase, then, initiates a transfer of funds from the card/account holder's bank account to the merchant in exchange for goods and services. The issuing bank typically is the bank that holds the account, and also is a member of the network(s) indicated on the particular card. From the network provider's perspective (e.g., Visa), the bank that caused the card to be issued is the “issuing bank.”

Identifying which networks are connected to a given account can often be accomplished by looking at the reverse side of a card, where the logos of the various networks, often called “bugs,” are printed. These various networks, when they are not specific to a particular merchant or venue, are called “open-loop” in the payments industry. Visa, MasterCard, Amex, Discover, and Star are examples of networks which, when associated with a card and account make the card “open-loop.” Conversely, accounts and their corresponding cards which are not open, but instead only perform their function at a particular store or chain of stores, or at a specific venue, are called “closed-loop.” Examples of closed-loop cards might be those issued by department stores such as Meyer & Frank, Nordstrom, or Old Navy. Those cards “work,” i.e., can be used to make a purchase, only within those stores. An Old Navy card will not work at a Nordstrom store, nor can it be used ‘at large’ to purchase gas, groceries, airline tickets, etc., as is true with open-loop cards such as Visa or MasterCard. It is noted that it is not necessarily a “card” that is open or closed-loop, but it is rather the nature of the account “behind” the card. As such, open and closed-loop account numbers can be just as easily associated with, e.g., cell phones, a key, or a voucher.

The power and attraction of open-loop cards is universal application and accessibility for commerce.

The power and attraction of closed-loop cards is that the stores/venues keep the money in their stores—so that gift cards and outstanding balances are more likely to be spent in the store that issued the card. If an open-loop card were used in place of a closed-loop card in such a store, the card holder might just as well spend the money elsewhere or even use an ATM to receive cash—and the store that issued the card would lose a sale. While they have this ability to ‘capture’ the consumer's money, closed-loop cards do not typically offer the protection of open-loop cards such as government banking regulations (e.g., Reg “E” disclosures), Visa's $0 liability for signature purchases, or FDIC deposit insurance, and more. Closed-loop cards can also be more difficult to get money “in and out” of since the number of locations and variety of means afforded to do so are typically much more restrictive than accounts in the banking system.

The problem to be solved by this invention is mainly one of perception, and then also convenience. The problem arises in the context of the Gaming industry, but the solution is applicable well beyond this particular industry, as will be appreciated by those skilled in the art. In the past, the Las Vegas Gaming Commission briefly allowed gaming establishments to connect their machines to the banking networks so that players could use their bank cards to pay for slots (one example). This experiment did not last long, as it was quickly deemed unacceptable that such establishments could ‘reach’ into consumers' bank accounts directly. This has resulted in somewhat convoluted solutions, where (as an example) a consumer uses an ATM (very expensive, fee-wise, on-site ATM) to get cash from their debit or credit card and then physically walks around a corner (e.g., 20-30 feet) to hand the money or some type of receipt to a cashier to put the money into a form that can be used with the machines on-site (e.g., a closed-loop card). The solution is rather awkward, and also, often times, far more expensive than a typical ATM implementation.

This awkward solution essentially connects the open-loop system of a consumer's choice (their personal credit, debit, check, or cash instruments) with the gaming establishment's close-loop system by using the consumer himself as a “courier” between the two. An advantage of this approach is that the consumer is clearly in control of the transaction. The disadvantages include the requirement to physically perform the task, which can include both time and distance at inopportune moments, and additionally (often) the expense of doing so.

As if to emphasize the matter of sensitivity towards public perception and possible negative associations with market branding and image, Visa and other financial transaction service providers have varying restrictions on the venues and types of merchants their cards are allowed to be used with. Gaming is explicitly excluded.

### SUMMARY OF THE INVENTION

The system and process described herein provides a complete solution and automates movement of funds between open and closed systems while still requiring the consumer to explicitly initiate the transfer. To simplify the process, the consumer is given access to either phone-enabled (IVR usable by cell or land phone) or web-enabled means to accomplish the movement of funds into and out of the closed-loop account from the open-loop account.

In an exemplary embodiment, there is provided:
a. An open-loop system, providing the consumer a FDIC insured bank account and connected to, e.g., the Visa international network and usable almost anywhere;
b. A closed-loop system, which can support issuance of various devices for the consumer to employ, such as tokens, vouchers, electronics ID, or even cell phones (but for the purposes of this description will be a card similar in appearance to any debit card);
c. A merchant-processing system which performs the same functions as in open-loop systems, allowing the merchant (in this example, a gaming establishment or device) to pull funds (make a purchase) from the closed-loop card. This system interacts with the closed-loop system to accomplish the transaction—and does so using the same techniques, hardware, and protocols as any open-loop system would; and
d. An interface between the open and closed systems that allows for the real-time adjustment of balances and transfer of funds.

The interface acts as a proxy, or escrow, for balances carried on the closed system accounts. As funds are moved into the closed account at a user's request, and reflected in their corresponding account balances (sometimes referred to as virtual accounts or sub-accounts), the actual funds on the open-loop system are moved from the consumer's account to a settlement account at the interface—providing safe escrow for the merchants (shops, games) in that the funds are “good funds,” meaning in-hand, and available for instant transfer to the merchant's open/closed accounts as purchases are made. Using this means of holding funds available for gaming, the merchant or game is not at risk of having the funds withdrawn during the course of a game—without their knowledge. Also beneficial is that the funds continue to reside in a bona-fide bank account at all times, continuously insured and regulated by the nation's banking system.

To use the system, the consumer would obtain an ‘open-loop’ account (and card) which was, e.g., Visa branded, or possibly just ATM and point-of-sale-capable and connected to a real bank account. They would then have the ability to get money into and out of this account as with any checking or savings account (direct-deposit/ACH, over the counter, mail-in, and more). This could be done by conventional paper application, online, or even on-site.

The consumer would also obtain a ‘closed-loop’ card (or other account number designator, including, for example, a cell phone telephone or account number). Again, the terms “open-loop” and “closed-loop” refer to whether a given account or card is ‘open’ to the financial and settlement community (stores, banks, ATMs), or is “closed” and only operates within a select network of systems, and in the context of the instant invention, are also are directly connected to the intermediate system or interface.

Using a cell phone and the interface's IVR (Interactive Voice Response), a customer can initiate movement of funds between his/her open and closed system accounts. Once the closed-loop card is funded, transactions are accomplished in the usual manner, as appropriate, to purchase goods and services on-site at a gaming establishment or to fund gaming (or simply to purchase goods or services).

What makes the system unique is that the open and closed systems can communicate with each other, and, at the consumer's initiative, funds can be transferred from the open system to the closed system. It is a “push” style transaction, completely within the consumer's control, and not a “pull” by the merchant—which avoids the perception problem mentioned previously above.

Furthermore, since the close-loop card is not branded with a bank, Visa, or some other transactional network provider's marks, there are no conflicts between use of the close-loop card and any of the banking or transactional network operating rules and regulations—or with governmental agencies by way of conflict with regulations concerning the use of the open-loop card.

In addition, IVR support means that a consumer can accomplish funds transfers quickly and easily without having to go anywhere—or leave the site (especially when the consumer uses a cell phone).

Finally, the consumer can push any available closed-loop funds back to their open-loop account at any time, to make them available for use at stores, ATMs, or withdrawals at a financial institution.

The proposed solution keeps funds movement in and out of the open-loop system and bank accounts buffered/separated from those environments deemed inappropriate by the payments industry, and completely in the explicit control of the account-holder.

These and other features of the present invention, along with their attendant advantages are described below in association with several drawing figures.

### BRIEF DESCRIPTION OF THE DRAWINGS

FIG. 1 depicts a general view of the major components of a system in accordance with an embodiment of the present invention.

FIG. 2 is a table that shows, sequentially, a relatively simple series of open and closed account balances for a single user/consumer and a single merchant in accordance with the present invention.

FIG. 3 is a table that shows, sequentially, a more detailed series of open and closed account balances for two users/consumers and, e.g., a single casino game in accordance with the present invention.

### DETAILED DESCRIPTION

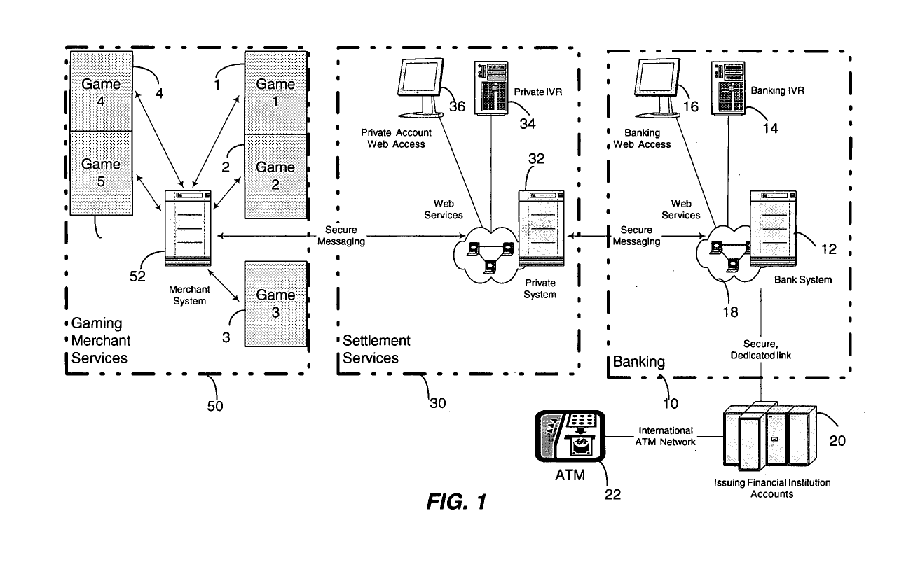

FIG. 1 depicts a general view of the major components of a system in accordance with an embodiment of the present invention. At a high level, there is a conventional banking system 10, network settlement services (NSS), or interface, 30 that acts as an intermediary payment system, and gaming or merchant services 50. Network settlement services (NSS) 30 acts as a go-between between banking system 10 and gaming or merchant services 50 as will be explained in more detail below.

Banking system 10 includes computer systems or means for bank card processing 12. The bank card processing means 12 operates in accordance with well-known and conventional standards. For instance, a customer can use Interactive Voice Response (IVR) 14 or online banking services 16 via network 18 to effect account management and funds transfers. Bank card processing means 12 is also in communication with issuing financial institution accounts 20 which are themselves accessible by customers via, for example, automatic teller machines (ATMs) 22 over the existing international ATM network. The present invention does not modify presently-available services available through banking system 10, but, as will be better appreciated from the description below, leverages these well-known services to fund closed-loop accounts in a unique manner.

Gaming and merchant services 50 includes a merchant system 52 and, in the case of a gaming implementation, a plurality of games 1-5 (which could also be point of sale terminals in the context of a conventional merchant). A customer generally has two options for making a purchase within a gaming or merchant environment. First, the customer can use an open-loop card/account to receive goods, services or access to gaming. However, as noted previously, open-loop networks such as Visa, expressly limit the use of their cards in gaming establishments. Thus, at least in the context of gaming, the direct use of an open-loop card is often not possible. The second option for a customer to obtain goods or services is to use a closed-loop card/account. A Casino or gaming establishment is a classic example of where a customer loads a card with a predetermined amount of money and then uses the card in, e.g., slot machines. (Merchants such as, e.g., Old Navy, Barnes & Noble, among others, have similar closed loop accounts that can be used at point of sale terminals and over the Internet.) This permits the gaming establishment or Casino to more easily track the usage of machines and patrons, and further eliminates the need to carry substantial amounts of cash or coins. The problem, as identified previously, is that it is difficult, especially in gaming environments, to transfer funds from an open-loop system such as one's credit card, check card, bank account, or the like to a closed-loop card like that provided by a Casino.

To solve this problem, network settlement services (NSS) or interface 30 acts as an intermediary payment system between banking system 10 and gaming and merchant services 50. More particularly, interface 30 establishes secure messaging between both bank card processing means 12 and merchant system 52. From banking system's 10 perspective interface 30 preferably “looks like” a consumer who is simply performing account to account transfers to a settlement account. That is, in accordance with the present invention, bank system 10 is employed to hold several accounts from and into which funds can be transferred. For instance, in the context of a gaming environment, a single bank within banking system 10 would hold open loop accounts for users/gamblers who also have corresponding closed loop accounts associated with, e.g., a Casino. Network settlement services or intermediary 30 would also hold an account with the same bank. Finally, the same bank would establish accounts for each of the games with which the closed loop accounts can be used. As such, all transactions with regard to loading a closed loop card/account from an open loop account, and using the closed loop card to, e.g., play slots, or buy chips, are performed by account-to-account transfers within the same bank. Thus, banking system 10 would ‘see’ account-to-account transfers from the settlement account to various merchant accounts, possibly in both directions, and at times ‘see’ the money being returned to the original consumer's account from the settlement account. In each case, movement perceived by banking system 10 is accomplished as a series of account-to-account transfers using the settlement services (30) account as an intermediary. It is noted that the several open loop accounts described herein need not necessarily be at the same financial institution or bank, as long as appropriate account to account transfers within an open loop system can be performed among the several accounts.

From the perspective of gaming or merchant services 50, interface 30 functions as a “closed” accounting system that is tied with merchant system 52.

In practice, a customer, perhaps using a cell phone, contacts IVR 34 of network settlement services 30. IVR 34 will prompt the customer for identification and password information, as necessary, and will allow the customer to transfer funds from banking system 10 to closed accounting system 32 (which is really an open loop account operated or controlled by NSS 30). In so doing, and because closed accounting system 32 and merchant system 52 are closely tied, merchant system 52 recognizes that the funds transferred are designated for that customer's closed-loop account that may be used at the gaming or merchant services establishment 50. Once funded, the closed-loop card essentially acts as a debit card within the environs of gaming or merchant services 50. The card can be replenished with funds from banking system 10 in response to further instructions from the customer, and the customer can likewise return funds from the closed-loop system to his/her open-loop account, again using IVR 34 or online system 36. A customer or consumer may also perform account transfers from a kiosk (not shown) that may include a computer system that provides world wide web access, or that has ATM functionality. Also, although IVR 34 may be used in a typical implementation, wireless devices generally (including cell phones) may also be used to cause funds transfers using non-voice communication, i.e., pure data communication exchange. In a preferred implementation, the customer or consumer is provided a confirmation message that funds have been successfully transferred. Such a confirmation message may be provided by a mobile phone SMS message, email, or any other convenient methodology.

Also, those skilled in the art will appreciate that the consumer may cause multiple “closed” transactions to take place without having to request a corresponding number of funds transfers into the closed system. That is, there is not necessarily a one-to-one relationship between open loop transfers and closed loop transactions.

Communication between merchant system 52 and NSS 30 may be implemented using XML exchanges that are proprietary between these entities. Funds transfers may also be effected by ACH, although such transactions may take many hours or even an entire day to clear. Still another way to move funds is to employ the open loop credit/debit “rails.” Although practical, movement of funds in this manner would likely be subject to charge-backs and interchange fees (perhaps 2-4%), which the parties might no want to shoulder.

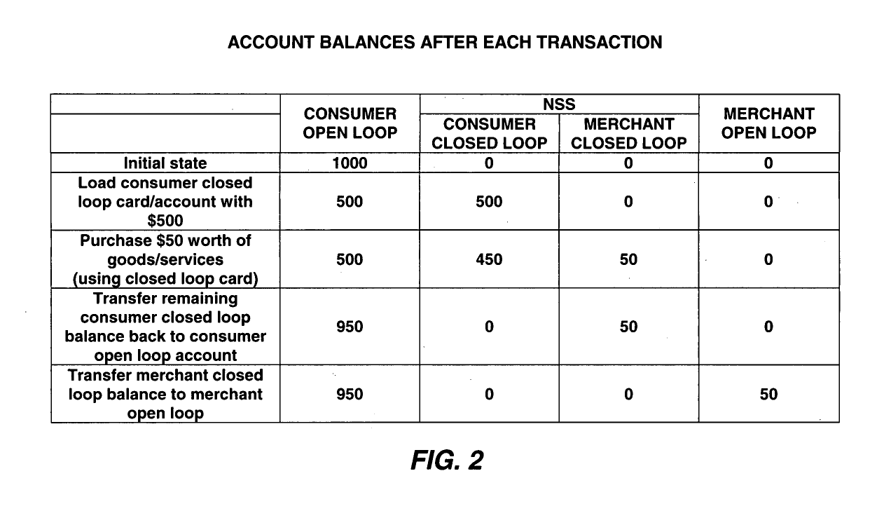

FIG. 2 is a table that shows a single consumer open loop account, a single merchant open loop account and a single network settlement service (NSS) open loop account that keeps track of respective closed loop accounts for the consumer and merchant. As is evident from FIG. 2, NSS 30 accounts for all closed loop transactions. As noted previously, even though closed loop transactions are occurring, the funds, from a bank's perspective, are all seen as being transferred among three different open loop accounts. NSS 30, however, operates as a proxy for the closed loop system, thus enabling significant control of funds by the consumer, and “safety” of funds for the merchant.

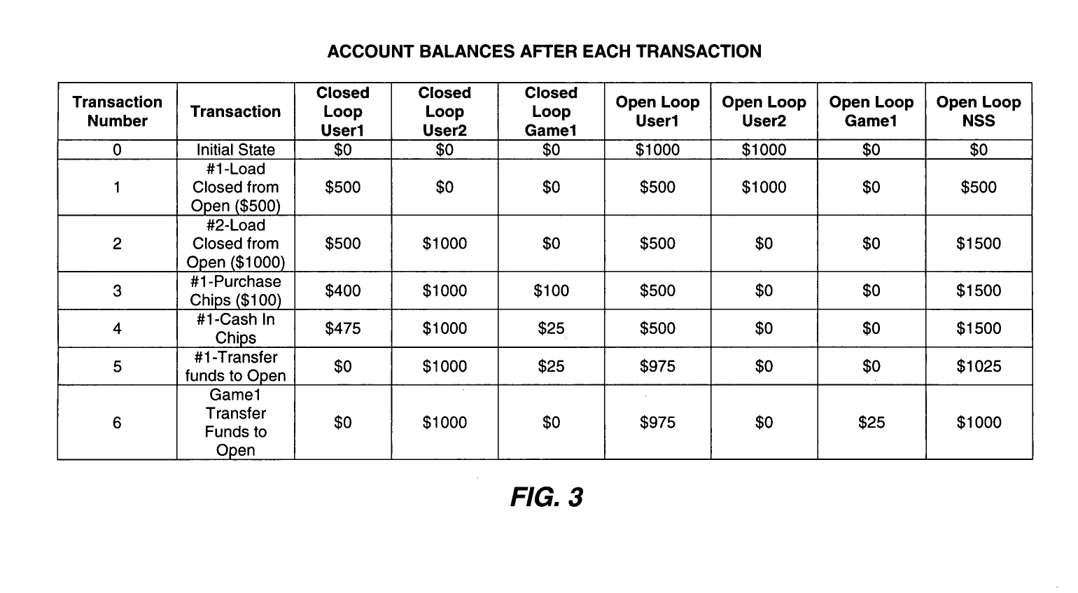

FIG. 3 is a table that shows, sequentially, a more complicated series of open and closed loop account balances for two users in accordance with the present invention. As will be appreciated by those skilled in the art, interface 30 can keep track of the transactions of multiple users or customers, consumers and games. The interface 30 itself appears as a single bank account from the perspective of banking system 10, but internally, identifies and designates the amount of funds for each of the users or customers and games.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For instance, the “accounts” described herein should be understood to also broadly include debit cards, checking cards (open-loop), and even closed-loop cards.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on any claims.

What is claimed is:

1. A method for bridging closed and open loop financial systems for the purpose of funding a closed loop gaming account, comprising:
establishing a first account at a financial institution, the first account being associated with an open loop financial system and being accessible to a user to effect funds transfers into and out of the first account;
establishing a second account at the financial institution, the second account also being associated with the open loop financial system and further being accessible to a gaming establishment that accepts payment via a closed loop financial system;
establishing a third account at the financial institution, the third account being associated with the open loop financial system and belonging to a settlement service that is neither the user nor the gaming establishment, the settlement service keeping track of a closed loop account balance belonging to the user and a closed loop account balance belonging to the gaming establishment;
receiving, at the settlement service, a request from the user that results in a transfer of funds from the first account to the third account, and which causes a corresponding increase in the closed loop account balance belonging to the user;
receiving, at the settlement service, an indication from the gaming establishment to cause an amount of funds to be transferred from the closed loop account balance belonging to the user to the closed loop account balance belonging to the gaming establishment; and
thereafter, transferring the amount of funds from the third account to the second account.

2. The method of claim 1, wherein the request is initiated from a telephone.

3. The method of claim 2, wherein the telephone is a cellular telephone.

4. The method of claim 1, wherein the request is initiated from a website.

5. The method of claim 1, further comprising communicating with the user via an interactive voice response (IVR) system associated with the settlement service.

6. The method of claim 1, further comprising establishing secure communications between the financial institution and the settlement service, and between the settlement service and the gaming establishment.

7. The method of claim 1, further comprising keeping track of a plurality of closed loop account balances belonging to a plurality of users and a plurality of closed loop account balances belonging to individual games of a gaming establishment.

8. The method of claim 1, wherein the gaming establishment is a casino.

9. The method of claim 1, wherein the financial institution is a bank.

10. The method of claim 1, wherein the indication is initiated by the use of a closed loop card.

11. A method of operating an intermediary payment system, comprising:
establishing a bank account, at a financial institution, that is controlled by an intermediary entity, the bank account being associated with an open loop financial system, the intermediary entity establishing closed loop financial system sub-accounts for each of a plurality of consumers and each of a plurality of gaming devices that accept payment via the closed loop financial system;
receiving a request, at the intermediary entity, from one of said consumers that results in funds being transferred from an open loop account belonging to said one of said consumers to said bank account that is controlled by said intermediary entity, said intermediary entity crediting said funds to the closed loop financial system sub-account belonging to said one of said consumers;
receiving an indication, at the intermediary entity, from one of said transactional entities that said one of said consumers wagered a given value of funds within the closed loop financial system;
debiting said given value of funds from said closed loop financial system sub-account belonging to said one of said consumers and crediting said given value of funds to the closed loop financial system sub-account belonging to said one of said gaming devices; and
transferring said given value of funds from said sub-account belonging to said one of said gaming devices to an open loop financial system bank account belonging to a casino that operates said one of said gaming devices.

12. The method of claim 11, wherein the request is initiated from a telephone.

13. The method of claim 12, wherein the telephone is a cellular telephone.

14. The method of claim 11, wherein the request is initiated from a website.

15. The method of claim 11, further comprising communicating with the consumer via an interactive voice response (IVR) system that is associated with the intermediary payment system.

16. The method of claim 11, further comprising establishing secure communications between the financial institution and the intermediary entity, and between the intermediary entity and the gaming device.

17. The method of claim 11, wherein the gaming device is a slot machine.

18. The method of claim 11, wherein the indication is initiated by the use of a closed loop card.

19. The method of claim 11, wherein a single given sub-account is associated with a plurality of gaming devices.

20. A method of transferring funds between an open loop financial system and a closed loop financial system of a casino, comprising:
issuing an open loop card and a casino closed loop card to a consumer, the open loop card being associated with an open loop account and the casino closed loop card being associated with a casino closed loop account that can be used to wager money within the casino;
receiving a request from the consumer, initiated from a mobile communications device, to transfer a selected amount of money from the open loop account to the casino closed loop account;
transferring the selected amount of money from the open loop account to the casino closed loop account;
receiving a notification that the consumer wagered an amount of money at a selected gaming machine within the casino;
debiting the casino closed loop account by an amount equivalent to the value of money wagered; and
crediting a virtual casino closed loop account by the amount equivalent of the value of money wagered,
wherein the casino closed loop account and the virtual casino closed loop account are provided for by an intermediary payment system that has an associated open loop account and that operates the casino closed loop account and virtual casino closed loop account as sub-accounts of the associated open loop account.
